(19) United States
(12) Patent Application Publication
(10) Pub. No.: US 2025/0256437 A1
(43) Pub. Date: Aug. 14, 2025

(54) INJECTION MOLDING FOR PRODUCING A PLASTIC MOLDED PART WITH INSERT

(71) Applicant: SUMMERER Technologies GmbH & Co. KG, Schechen (DE)

(72) Inventors: Franz Josef Summerer, Gstadt am Chiemsee (DE); Marco Oswald, Rosenheim (DE)

(21) Appl. No.: 19/052,565

(22) Filed: Feb. 13, 2025

(30) Foreign Application Priority Data
Feb. 14, 2024 (DE) 10 2024 104 155.2
Jan. 23, 2025 (DE) 10 2025 102 354.9

(51) Int. Cl. B29C 45/14; B29C 45/17; B29K 75/00; B29K 669/00

(52) U.S. Cl. CPC B29C 45/14065; B29C 45/174; B29C 2045/14155; B29K 2075/00; B29K 2669/00; B29K 2995/002; B29K 2995/0026

(57) ABSTRACT

A method of producing a plastic molded part with an insert by injection molding uses an injection mold which includes first and second mold halves configured to form an injection molding cavity when closed. The first mold half includes a contour surface in which a linear vacuum slot extends. The linear vacuum slot is provided with transverse slots in order to form a band-shaped vacuum region, via which the insert is fixable to the contour surface by applying a vacuum. The method comprises inserting the insert into the first mold half, which is fixed to the contour surface by applying a vacuum to the contour surface by means of the band-shaped vacuum region. After the insert has been fixed, the plastic compound is injected into the injection molding cavity. After the plastic compound has solidified, the plastic molded part with insert is removed from the injection mold.

### CROSS-REFERENCE TO RELATED APPLICATIONS

This application claims priority to German Patent Application 102024104155.2, filed on Feb. 14, 2024, and German Patent Application 102025102354.9, filed on Jan. 23, 2025. German Patent Application 102024104155.2 and German Patent Application 102025102354.9 are incorporated herein by reference.

### TECHNICAL FIELD

The invention relates to an injection molding method of producing a plastic molded part with an insert. Furthermore, the invention relates to an injection mold and to a plastic molded part with an insert.

### BACKGROUND

It is already known to place inserts, for example foils, in an injection molding cavity and back-inject them. In this way, plastic molded parts can be produced with a surface formed by the insert. Such in-mold processes make it possible, for example, to integrate inserts with functional elements (e.g. electrical or electronic or optical functional layers) into the plastic molded part or to produce decorative parts whose appearance can be determined by the foil design.

A known problem is that the insert is exposed to sliding forces during the injection process, which can lead to wrinkling or slippage of the insert in the injection molding cavity. Particularly in the case of plastic molded parts with curved surfaces, it is often difficult to secure the position of the insert during the injection process.

It is already known to use a line slot vacuum to hold the insert in the mold, by means of which the insert is sucked onto the cavity surface along the slot line. The problem is that the effect of the line slot vacuum is comparatively small and in some cases, especially with a curved surface of the molded part, cannot reliably prevent the insert from slipping during the injection process.

To increase the effect of a linear vacuum, the slot width must be increased, which in turn increases the surface defects (impression of the vacuum slot on the surface of the insert) caused by the injection pressure and by the vacuum application.

In many cases, it is necessary to use a preformed insert to ensure precise positioning of the insert on the line slot, which is required to generate the vacuum. In this case, a further process step (preforming of the insert) is required, which increases the cost of the overall process.

### SUMMARY

An object of the disclosure may, e.g., be seen in providing a method of producing a plastic molded part with an insert, which improves the retention of an insert in the injection mold in a simple manner. In particular, the method aims to hold the insert in the mold in a process-reliable manner. Furthermore, the disclosure aims to create a plastic molded part which has a plastic component and an insert back-injected by the plastic component, wherein the insert is realized with as few defects as possible in the area in which it was fixed in the injection molding cavity by means of a vacuum.

### First Aspect of the Disclosure:

According to a first aspect, a method of producing a plastic molded part with an insert by injection molding uses an injection mold which comprises a first mold half and a second mold half. The two mold halves are configured to form an injection molding cavity when closed. The first mold half includes a contour surface in which a linear vacuum slot extends. The linear vacuum slot is provided with transverse slots in the contour surface in order to form a band-shaped vacuum region on the contour surface, via which the insert is fixable to the contour surface by applying a vacuum. The method comprises inserting the insert into the first mold half of the injection mold. The insert is fixed to the contour surface of the first mold half by applying a vacuum to the contour surface by means of the band-shaped vacuum region. After the insert has been fixed in place, the plastic compound is injected into the injection molding cavity. After the plastic compound has solidified, the plastic molded part with insert is removed from the injection mold.

Preferably, before the insertion of the insert, the insert is not preformed according to the shape of the contour surface. This step can be omitted, since the effect of the band-shaped vacuum region according to the disclosure ensures secure vacuum formation and secure adhesion of the insert even without preforming it.

The transverse slots significantly increase the holding force with which the insert is held in the molding cavity. A secure adhesion of the insert to the contour surface is achieved, which significantly increases process reliability during the production of the plastic molded part. In addition, it is possible to reduce the surface defect caused by the vacuum application by reducing the slot width compared to a conventional line slot vacuum. Furthermore, due to the band-shaped vacuum region, a more reliable suction and thus a more reliable vacuum formation between the contour surface and the insert can be ensured. Even if the insert is not in contact with the band-shaped vacuum region everywhere, the “residual vacuum” is usually sufficient to hold the insert securely. This significantly increases process reliability. For example, it is possible to dispense with preforming the insert, even with curved surfaces, which saves costs

According to a first example, the transverse slots can extend away only from one side of the linear vacuum slot. In this case, the band-shaped vacuum region is defined on one side by the linear vacuum slot and on the other side by the end of the transverse slots. The width of the band-shaped vacuum region can thus be set by means of the slot length.

According to a second example, the transverse slots can extend away from both sides of the linear vacuum slot. Compared to the first example, the width of the band-shaped vacuum region can thus be increased (e.g. doubled). The width of the band-shaped vacuum region is determined here by the sum of the lengths of the transverse slots on both sides of the linear vacuum slot plus the slot width of the vacuum slot.

A plastic molded part comprises a plastic component and an insert, in particular a foil, which is back-injected (overmolded) by the plastic component. An outer surface of the insert has a linear impression with web-like transverse impressions. The impressions are created by the band-shaped vacuum region on the contour surface of the first mold half. Due to the improved vacuum effect, the impressions can be finer and thus more optically discreet than when using a linear vacuum slot. As a result, the optical defects on the plastic molded part that inevitably arise from the use of vacuum can be reduced.

### Second Aspect of the Disclosure:

According to a second aspect, a method of producing a plastic molded part with an insert by injection molding uses an injection mold which comprises a first mold half and a second mold half. The two mold halves are configured to form an injection molding cavity when closed. The first mold half includes a contour surface in which a linear vacuum slot extends. The linear vacuum slot comprises an oscillating line path in order to form a band-shaped vacuum region on the contour surface, via which the insert is fixable to the contour surface by applying a vacuum. The method comprises inserting the insert into the first mold half of the injection mold. The insert is fixed to the contour surface of the first mold half by applying a vacuum to the contour surface by means of the band-shaped vacuum region. After the insert has been fixed in place, the plastic compound is injected into the injection molding cavity. After the plastic compound has solidified, the plastic molded part with insert is removed from the injection mold.

The oscillating line path significantly increases the holding force with which the insert is held by suction in the molding cavity. A secure adhesion of the insert to the contour surface is achieved, which significantly increases process reliability during the production of the plastic molded part. Furthermore, by reducing the slot width compared to a straight line slot vacuum, it is possible to reduce the surface defect created by the vacuum application.

Furthermore, due to the band-shaped vacuum region, a more reliable suction and thus a more reliable vacuum formation between the contour surface and the insert can be ensured. Even if the insert is not in contact with the band-shaped vacuum region everywhere, the “residual vacuum” is usually sufficient to hold the insert securely. This significantly increases process reliability. For example, it is possible to dispense with preforming the insert, even with curved plastic molded part surfaces, which saves costs.

The oscillating line path can be free of kinks at least in certain areas or as a whole, in particular, e.g., at the reversal points (maxima, minima) of the oscillations. Alternatively or additionally, the oscillating line path can be realized without transverse slots. In these or other cases, there are no sharp corners or crossing points in the line path. Sharp corners or crossing points in the line path can be problematic with regard to the creation of optical defects (e.g. color imprints).

The oscillating line path can be realized at least in some areas as a multi-curved, serpentine, wavy, meandering or polygonal line, the latter in particular with rounded corners.

The first mold half can be designed with a receptacle. A mold insert may be arranged in the receptacle, and the linear vacuum slot can be defined (delimited) by a side wall of the mold insert and a side wall of the receptacle. In other examples, a further mold insert may be arranged in the receptacle and the linear vacuum slot can be defined (delimited) by a side wall of the mold insert and a side wall of the further mold insert. The shaping of the opposing side walls can be realized with high precision by means of milling. In particular, this way it is possible to achieve the small slot widths mentioned below.

The disclosure also relates to a plastic molded part which has a plastic component and an insert, in particular a foil, which is back-injected (overmolded) by the plastic component. An outer surface of the insert has a linear impression with an oscillating line pattern. The impression is created by the band-shaped vacuum region on the contour surface of the first mold half. Due to the improved vacuum effect, the imprints can be finer and therefore less visually striking than would be the case if a straight vacuum slot were used. In this way, the optical defects on the plastic molded part that inevitably arise from the use of vacuum can be reduced. In particular, the risk of defects caused by corners or intersections or crossings of the vacuum slot can be avoided.

### Third Aspect of the Disclosure:

The disclosure pertains to a method of producing a plastic molded part with an insert by injection molding. The method comprises inserting an insert into a first mold half of an injection mold. An injection molding cavity is formed by closing the first mold half with a second mold half. The insert is fixed to a contour surface of the first mold half by applying a vacuum by means of one or more vacuum slots in the contour surface. A plastic compound is injected into the injection molding cavity. During or before a cooling phase of the not-yet solidified plastic compound, the vacuum is switched to an overpressure. The plastic molded part with insert is demolded.

### BRIEF DESCRIPTION OF THE DRAWINGS

Examples are depicted in the drawings and are exemplarily detailed in the description which follows. The elements of the drawings are not necessarily to scale relative to each other. Like reference numerals designate corresponding similar parts. Features of the illustrated examples may be selectively combined with each other, provided that they are not alternative or technically mutually exclusive features. Furthermore, features of the examples can be selectively omitted, unless they are described as mandatory features in the description.

FIG. 1 is a schematic cross-sectional view of an exemplary injection mold.

FIG. 2 is a top view of a first mold half with a linear vacuum slot.

FIG. 3 shows two examples A and B of band-shaped vacuum regions according to the first aspect of the disclosure, which are formed by transverse slots extending away from the linear vacuum slot on one side.

FIG. 4 shows two examples C and D of band-shaped vacuum regions according to the first aspect of the disclosure, which are formed by transverse slots extending away from the linear vacuum slot on one side (example C) or transverse slots extending away from the linear vacuum slot on both sides (example D).

FIG. 5 is a side view of an example of an insert according to the first aspect of the disclosure, looking towards the side wall of the insert, which delimits the linear vacuum slot and has vacuum channels for the transverse slots.

FIG. 6 is a top view of an example of a plastic molded part with insert according to the first aspect of the disclosure.

FIG. 7 is an example of a band-shaped vacuum region according to the second aspect of the disclosure, which is formed by a vacuum slot with an oscillating line path.

FIGS. 8A to 8D are examples of an oscillating line path.

### DETAILED DESCRIPTION

FIG. 1 shows a schematic sectional view of an injection mold 100. The injection mold 100 has a first mold half 110 and a second mold half 120. In the closed state, which is shown in FIG. 1, an injection molding cavity 130 is formed between the mold halves 110 and 120.

The injection molding cavity 130 is sealed, for example, at edge regions 112, 122 of the first mold half 110 or the second mold half 120. Not shown in FIG. 1 is a plastic feed (runner) which makes it possible to introduce plastic material into the injection molding cavity 130.

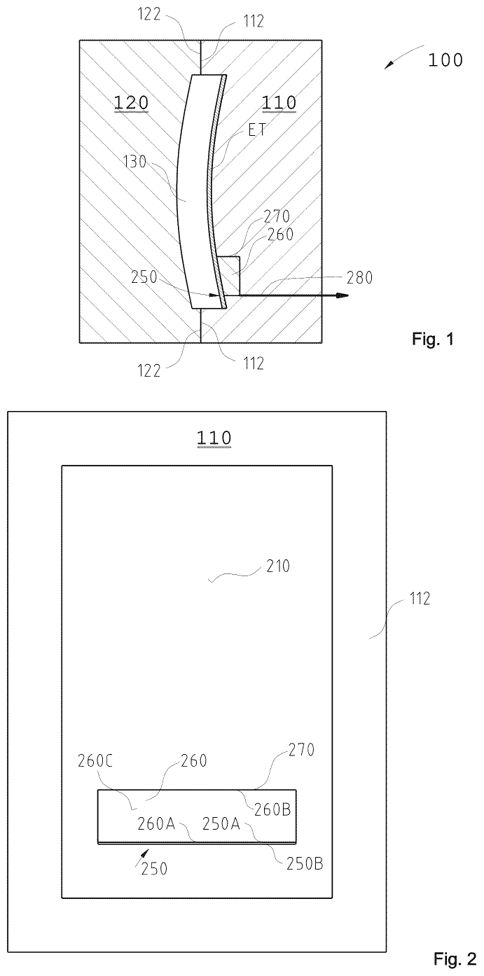

FIG. 2 shows the first mold half 110 in top view. The first mold half 110 has a contour surface 210 which can be encompassed by the edge region 112 of the first mold half 110.

A linear vacuum slot 250 is formed in the contour surface 210. The linear vacuum slot 250 is delimited by two opposing slot walls 250A and 250B.

For example, the slot wall 250A can be formed by a side wall of a mold insert 260. The mold insert 260 can be arranged in a receptacle 270 of the first mold half 110. In this case, the slot wall 250B can be realized by a side wall of the receptacle 270.

The receptacle 270 can, for example, be realized as a recess in the contour surface 210. The mold insert 260 can, for example, be received in the receptacle 270 with its side wall 260B opposite the slot wall 250A without a gap. In this case, a surface 260C of the mold insert 260 can serve as a contour surface, which continues the contour surface 210 of the first mold half 110 at the transition from the receptacle 270 to the mold insert 260 (i.e., at the line defined by the side wall 260A) flush, without steps and/or without kinks, for example.

FIG. 1 also schematically shows a vacuum supply 280, via which a vacuum (or suction) can be applied to the vacuum slot 250.

Before the injection process, an insert ET (see FIG. 1) is inserted into the first mold half 110. The insert ET can, for example, be a foil or another, e.g. flat, insert ET.

Inserts ET differ from a plastic component of the molded plastic part to be manufactured in that they are prefabricated. That is, an insert ET is not formed in the injection molding process described herein, but is inserted into the injection molding cavity 130 (for example, into the first mold half 110) and then overmolded (back-molded) with the plastic compound.

The insert ET can, for example, be a decorative element that determines the appearance of the molded plastic part to be produced. It is also possible for the insert ET to be an electrical, electronic or optical functional element, such as a heating foil with integrated heating wires, an electronic circuit on a flexible circuit board, or a display, etc.

The insert ET may contain or be a foil, e.g. PC (polycarbonate) foil. The thickness of the foil can be between 0.1 mm and 1 mm, in particular between 0.3 mm and 0.6 mm.

Since foils of this thickness have a certain inherent tension, it is necessary in the art in many cases to place the insert ET as a preformed foil into the first mold half 110. This ensures that the insert ET fits snugly against the linear vacuum slot 250 and seals it. In the applications described here, however, it is also possible to place the insert ET into the injection molding cavity 130 without preforming, i.e. with a residual stress. As will be explained in more detail below, this is made possible by the fact that the vacuum region is realized in the form of a band (or strip) according to the invention, so that secure vacuum and retention of the insert ET can be ensured in the area of the vacuum slot 250 even without a dimensionally accurate (form-complementary) contact of the insert ET with the contour surface 210.

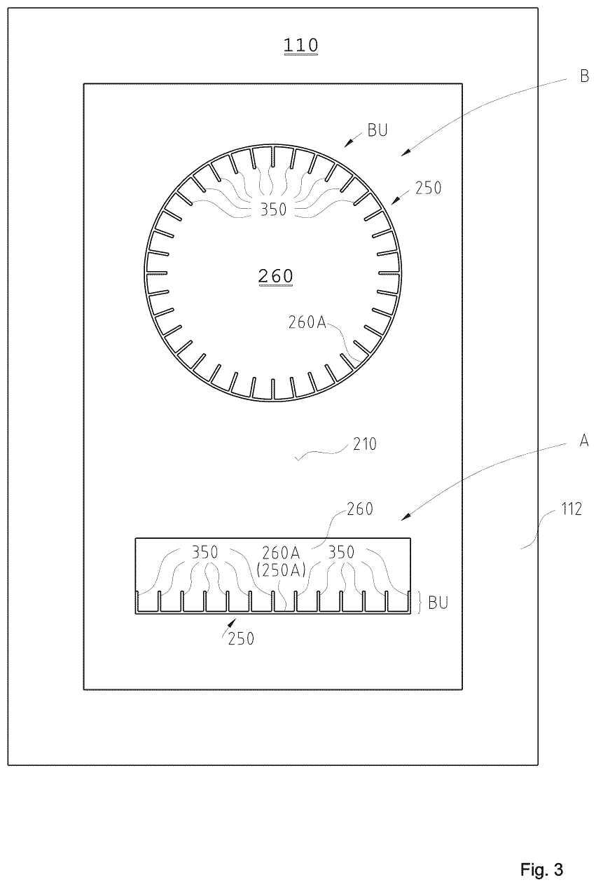

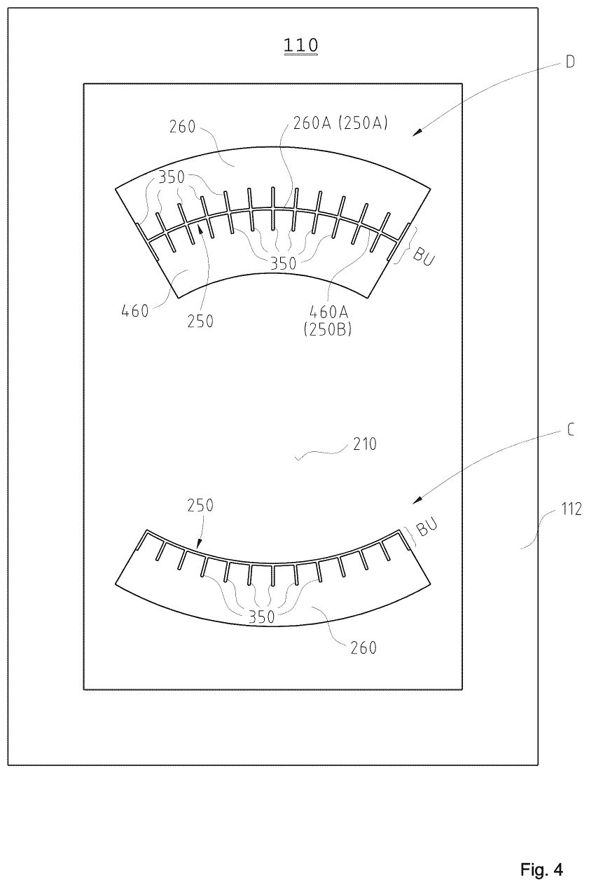

FIGS. 3 and 4 show four different examples A, B, C and D for realizing a band-shaped vacuum region on the contour surface 210 of the first mold half 110. Referring to FIG. 3, example A, the linear vacuum slot 250 described in FIG. 2 is provided with transverse slots 350. In the example shown here, the transverse slots 350 extend away from only one side (slot wall 250A) of the linear vacuum slot 250. The transverse slots 350 open into the linear vacuum slot 250 and are manufactured in the mold insert 260, for example.

The area formed by the linear vacuum slot 250 and the transverse slots 350 is also referred to below as the band-shaped vacuum region BU. In the example A shown in the lower part of FIG. 3, the band-shaped vacuum region BU is rectangular. The width of the band-shaped vacuum region BU is determined by the slot width of the vacuum slot 250 plus the length of the transverse slots 350.

In all examples, the band-shaped vacuum region BU can be realized, for example, in the vicinity of a plastic feed (not shown). For example, in FIG. 3, Example A, such a plastic feed (runner) can be arranged at the lower cavity boundary (edge region 112), so that an insert ET (not shown) is held near the injection point by the band-shaped vacuum region BU.

FIG. 3, example B, shows another possible realization of a band-shaped vacuum region BU. The band-shaped vacuum region BU is realized here, for example, as a circumferential band.

In particular, the circumferential band can be closed, e.g. ring-shaped or circular.

Such a structure can be formed, for example, by a mold insert 260 whose side wall 260A (which forms a slot wall 250A) is provided with transverse slots 350 all around. For example, the mold insert 260 may be circular disk-shaped or have another shape (e.g. polygonal, possibly with rounded corners).

In this example, the plastic feed (not shown) can, for example, be arranged in the second mold half 120 above, in particular centrally above, the mold insert 260.

Further examples C and D with curved band-shaped vacuum regions BU are shown in FIG. 4. In example C, the band-shaped vacuum region BU is shaped, for example, as a segment of a circle. To avoid repetition, reference is made to the description of FIG. 3.

In the upper part of FIG. 4, example D, a band-shaped vacuum region BU is shown, in which the transverse slots 350 extend away from both sides of the linear vacuum slot 250. Such a band-shaped vacuum region BU can be realized, for example, by a further mold insert 460, in which further transverse slots 350 extend, which open into the linear vacuum slot 250. In this case, the slot walls 250A, 250B of the linear vacuum slot 250 can be formed, for example, by a side wall 260A of the mold insert 260 and an opposite side wall 460A of the further mold insert 460.

The transverse slots 350 in the two mold inserts 260, 460 can be aligned with one another (see FIG. 4). However, it is also possible for the transverse slots 350 to be arranged at an offset to one another (for example half the slot spacing) along the linear vacuum slot 250.

Since the insert ET (for example foil) is back-injected at high pressure, the slot width of the transverse slots 350 and/or the linear vacuum slot 250 may only be a few hundredths of a millimeter. For example, the slot width of the linear vacuum slot 250 and/or the transverse slots 350 may be equal to or less than 0.1 mm, 0.08 mm, 0.06 mm, 0.05 mm or 0.04 mm. In many cases, the slot width will be between 0.03 mm and 0.06 mm, for example, in order to keep markings (impressions) of the slots on the product (molded plastic part) to a minimum.

A further advantage of a small slot width (e.g. equal to or less than 0.06 mm, 0.05 mm or 0.04 mm), which is important in practice and which can be achieved by providing a band-shaped vacuum region BU, is that liquid plastic compound cannot pass through such narrow slots and enter the vacuum system if the insert ET does not completely cover the band-shaped vacuum region BU. An only partial covering of the band-shaped vacuum region BU by the insert ET can either occur unintentionally as a result of slippage of the insert ET during the injection molding process or—according to the invention with a small slot width—can now also be intentional, since the vacuum system can be protected against penetration of liquid plastic compound by the small slot width.

In all examples, a length of the transverse slots 350 may be equal to or less than 10 mm, 5 mm, 3 mm or 1 mm. Even if the length of the transverse slots 350 is only about 1 mm, the effect of the vacuum is increased many times over a linear vacuum, while at the same time significantly fewer marks (impressions) can be achieved on the visible side of the insert ET (e.g. foil).

The shorter the transverse slots 350 are, the smaller a distance between adjacent transverse slots 350 can be selected. With longer transverse slot lengths, a greater distance between the transverse slots 350 is required in order to ensure sufficient stability of the contour surface 210 in the band-shaped vacuum region BU (because, as will be explained in more detail below, the depth of the transverse slots 350 may be chosen as small as possible). For example, a distance between adjacent transverse slots 350 may be in the range between 0.5 mm or 1 mm and about 2 mm for a transverse slot length of, for example, 1 mm. For a transverse slot length of, for example, 5 mm, a distance between adjacent transverse slots 350 may be, for example, between 3 mm or 5 mm and 10 mm.

In general, a distance between adjacent transverse slots 350 can be e.g. equal to or less or more than 20 mm, 10 mm, 8 mm, 5 mm, 3 mm, 2 mm, 1 mm or 0.5 mm. A slot width of the linear slot 250 and the transverse slots 350 may be the same or different and each may be equal to or less or more than 0.1 mm, 0.08 mm, 0.06 mm, 0.04 mm, 0.03 mm or 0.02 mm.

In all examples, the length of the linear vacuum slot 250 may be substantially greater than the length of the transverse slots 350. For example, the length of the vacuum slot 250 may be equal to or greater than 0.1 m, 0.3 m, 0.5 m, or 0.7 m.

In the examples shown here, the transverse slots 350 run perpendicular to the linear vacuum slot 250. However, it is also possible for the transverse slots 350 to be oriented obliquely, i.e. at an angle other than 90° to the linear vacuum slot 250. The fine transverse slots 350 can be produced, for example, by laser cutting, micro-milling or micro-cutting.

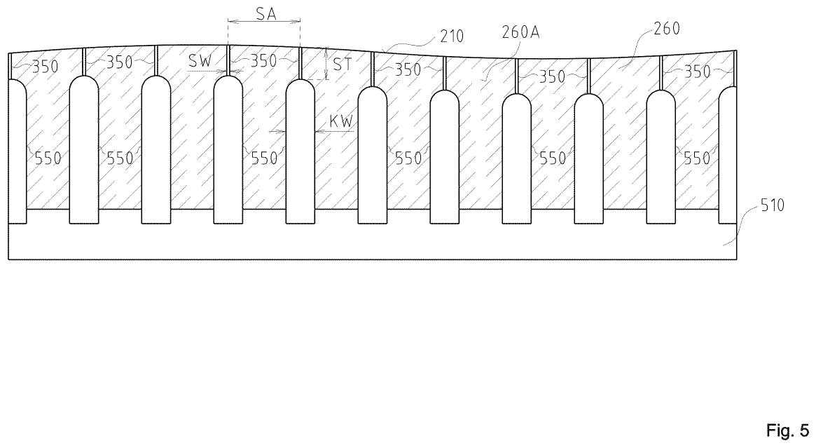

FIG. 5 shows a side view of a mold insert 260 looking towards the side wall 260A, which defines the slot wall 250A of the linear vacuum slot 250. The transverse slots 350 are connected to a vacuum system. In the example shown here, the vacuum system may comprise vacuum channels 550 each extending below the transverse slots 350 and communicating with the transverse slots 350. The vacuum channels 550 may, e.g., open into a longitudinal channel 510 of the vacuum system, which extends along and below the linear vacuum slot 250.

Via the longitudinal channel 510, a vacuum can be applied both to the longitudinal vacuum slot 250 and—via the transverse vacuum channels 550—to the transverse slots 350.

In order to keep the vacuum losses in the transverse slots 350 as small as possible even with small slot widths SW of the transverse slots 350, it is advantageous to keep the slot depth ST as small as possible. The slot depth ST is measured between the contour surface 210 and the upper end of the vacuum channel 550, where the transverse slot 350 widens into the vacuum channel 550. The vacuum channel 550 has a significantly larger channel width KW than the slot width SW, as a result of which much lower vacuum losses occur in the vacuum channel 550 than in the transverse slots 350. For example, the channel width KW can be greater than the slot width SW of the transverse slots 350 by a factor equal to or greater than 3, 5 or 10.

On the other hand, due to the channel width KW of the vacuum channels 550 and the desired small slot depth ST, the distance SA between adjacent transverse slots 350 can only be reduced as a function of the slot length, since the stability of the contour surface 210 in the band-shaped vacuum region BU decreases with longer slot lengths. The slot depth ST should therefore be equal to or less or more than 5 mm, 2 mm, 1 mm, 0.5 mm or 0.1 mm.

The presence of the transverse slots 350 also makes it possible to set the slot width of the linear vacuum slot 250 very small. In principle, it is even possible to reduce the slot width of the linear vacuum slot 250 to 0, whereby the vacuum application in the band-shaped vacuum region BU is then effected solely by the transverse slots 350. In most cases, however, the linear vacuum slot 250 is maintained, whereby the transverse slots 350 according to the disclosure enable a significant reduction in the slot width of the linear vacuum slot 250 compared to the example of FIG. 2 (without transverse slots 350). As a result, optical defects on the product (molded plastic part), which arise due to the application of vacuum, can be reduced.

The first aspect of the disclosure also relates to an injection mold for producing a plastic molded part with an insert. The injection mold comprises a first mold half and a second mold half. The two mold halves are configured to form an injection molding cavity when closed. The first mold half includes a contour surface in which a linear vacuum slot extends. The linear vacuum slot is provided with transverse slots in the contour surface in order to form a band-shaped vacuum region on the contour surface, via which the insert is fixable to the contour surface by applying a vacuum.

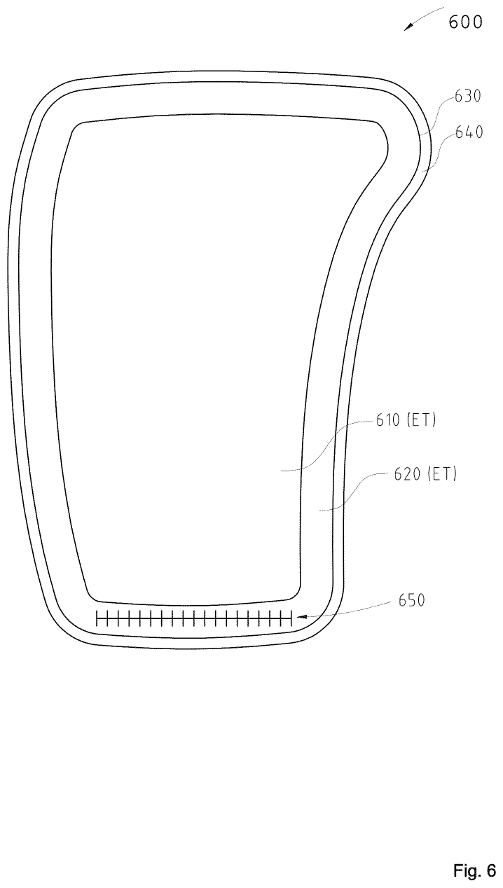

FIG. 6 shows a schematic view of an example of a molded plastic part 600 including a plastic component 640 and the insert ET. The molded plastic part 600 can be a flat and/or sheet-like part whose thickness is, for example, only a few millimeters (for example, less than one centimeter). The visible side of the molded plastic part 600 is shown, which is at least partially formed by the insert ET (e.g. foil). The molded plastic part 600 can be obtained by using the described injection molding process with vacuum application and demolding (removing) it from the injection molding cavity 130.

In the example shown, the plastic component 640 surrounds the insert ET, for example, and is therefore visible in the top view as the surround of the insert ET. The peripheral edge of the insert ET is identified by the reference sign 630. In contrast, in the cavity 130 shown in FIG. 1, the peripheral edge of the plastic component 640 would be flush with the peripheral edge 630 of the insert ET, for example.

In the example shown, the insert ET has a transparent central area 610 and an outer area 620, which is colored (e.g. black). However, it is also possible for the insert ET to have a different design, for example to be transparent over its entire surface or colored over its entire surface (e.g. black).

On the surface of the insert ET, where the insert ET is held by the band-shaped vacuum region BU, an impression 650 of the band-shaped vacuum region BU is formed. This means that the band-shaped vacuum region BU is more or less clearly visible on the product as a surface unevenness in the form of a raised embossing (raised marking). The embossings (of impression 650) each have two parallel edge lines, which are caused by the slot edges (in conjunction with the vacuum and the injection molding pressure) and mark them out. The dimensions of the parallel edge lines of the linear impression and the web-like transverse impressions correspond to the dimensions of the corresponding linear and transverse slots.

Paint may also flake off the impression 650. Furthermore, the linear impression with the web-like transverse impressions can also become visible in the plastic component, i.e. be transferred to the plastic component as a surface defect. The impression 650 is characteristic of the injection mold according to the disclosure or the process according to the disclosure with which the plastic molded part 600 is produced.

It has been found that due to the band-shaped vacuum region BU according to the disclosure, an impression 650 can be produced which is hardly visible and represents a significantly smaller optical defect on the plastic molded part 600 than would be the case with an injection mold or manufacturing process according to FIG. 2.

The impression 650 is optically detectable on the finished molded plastic part 600, e.g. it is optically recognizable with the eye under direct illumination and possibly also haptically perceptible or at least detectable as a surface unevenness. As shown, it can be placed in a colored area 620, for example, so that it is barely or, e.g., not at all visible to the eye on the molded plastic part 600.

According to an example, the insert ET may form a visible surface (e.g., outer surface) of the molded plastic part 600. This can optionally be overmolded with a further plastic component (not shown), e.g. with a transparent and/or colored polyurethane (so-called PUR flooding). Since the optical defect caused by the band-shaped vacuum region BU is already relatively small according to the disclosure, it is possible to produce a further significant defect reduction or a defect-free outer skin by PUR flooding of the insert ET. For example, the optical defect can either be reduced by PUR flooding covering the impression 650 to such an extent that it can be tolerated on a visible surface of the molded plastic part, or it can be eliminated (the latter can be achieved in particular by PUR flooding with colored PUR). In these or other examples, it is also possible that the insert ET forms a rear side (e.g. inner side, non-visible surface) of the molded plastic part 60. This can optionally be overmolded by a further plastic component (not shown).

In the method of manufacturing a plastic molded part 600 with an insert ET, the fixing of the insert ET to a contour surface 210 of the first mold half 110 can be performed by applying a vacuum by means of the band-shaped vacuum region BU, for example, before closing the first mold half 110 and the second mold half 120. The impression 650 on the insert ET is already caused to a small extent by the application of the vacuum, but mainly by the injection molding pressure when plastic material is injected into the injection molding cavity 130, i.e. the impression 650 is essentially formed during the injection molding phase.

The plastic molded part 600 with insert is demolded after the plastic compound has solidified. It is possible that further plastic component(s) are injected before demolding in order to form a multi-component plastic molded part 600. For example, one or more further plastic components can be injected onto the plastic component. Furthermore, it is possible that (possibly after removal of the molded plastic part from the cavity 130) the molded plastic part is further processed by injecting a further plastic component over the insert ET (e.g., as already mentioned, in the form of PUR flooding).

The removal of the plastic molded part 600 can be facilitated by means of the band-shaped vacuum region BU by supplying it with an overpressure that releases the plastic molded part 600 from the contour surface of the first mold half 110.

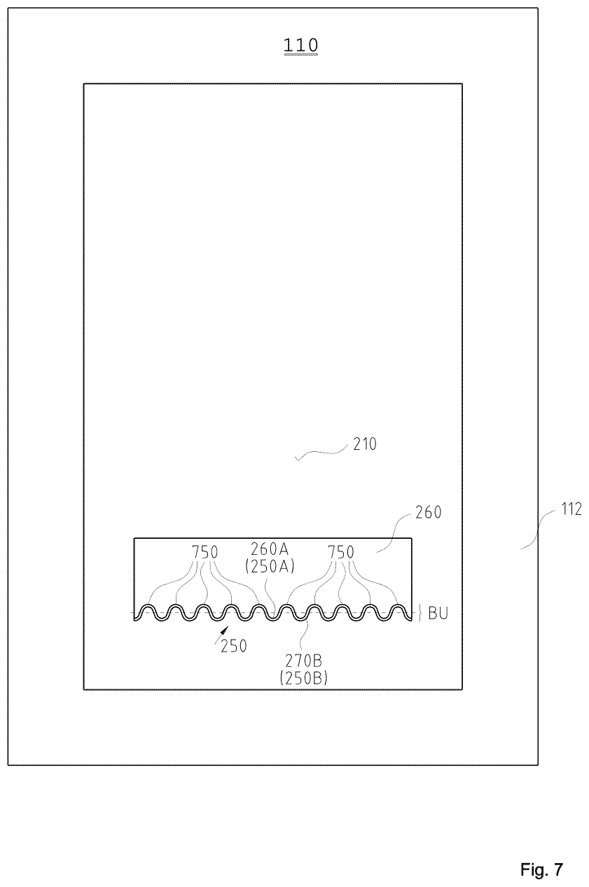

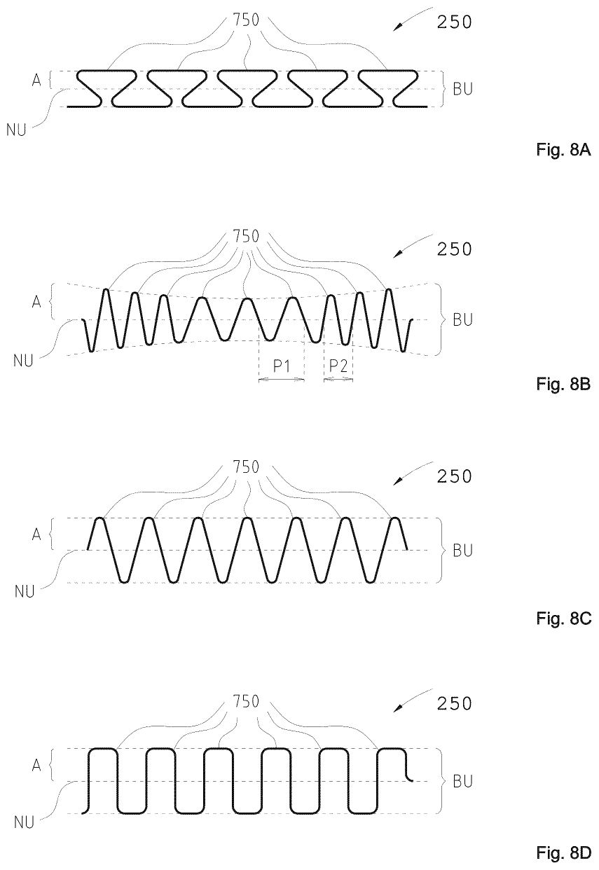

According to the second aspect of the disclosure, the vacuum slot can have an oscillating path, wherein the band vacuum is formed by the amplitude of the oscillations. FIG. 7 shows an example of a band-shaped vacuum region BU according to the second aspect. The band-shaped vacuum region BU is formed by a vacuum slot 250 with an oscillating line path. Further examples of vacuum slots 250 with oscillating line paths are shown in FIGS. 8A to 8D.

In the example shown in FIG. 7, the band-shaped vacuum region BU is straight. However, it can also be curved or bent (compare FIG. 3, above, and FIG. 4).

The width of the band-shaped vacuum region BU is determined by the amplitude of the oscillating line. It can be constant or vary along the path of the line (see e.g. FIG. 8B).

Analogous to FIGS. 3 and 4, in all examples the band-shaped vacuum region BU can be realized, for example, in the vicinity of a plastic feed (not shown). For example, such a plastic feed in FIG. 7 can be arranged at the lower cavity boundary (edge region 112), so that an insert ET (not shown) is held near the injection point by the band-shaped vacuum region BU.

The vacuum slot 250 can, for example, be formed by a mold insert 260, the side wall 260A of which forms one slot wall 250A. The other slot wall 250B can be realized by an opposite side wall 270B of the receptacle 270 or of another mold insert as described above. The slot walls can be manufactured by milling with extremely high precision in the range of less than 0.01 mm surface tolerance. In this respect, smaller slot widths of the linear vacuum slot 250 are possible than the widths of the transverse slots 350 that can be produced by micro-cutting (sawing) in the first aspect of the disclosure.

The oscillations 750 of the line can, but do not have to be periodic. For example, a period P can vary along the path of the line (see e.g. FIG. 8B). That is, P1 can be different from P2 (whereby an average period results from the sum of all period lengths divided by the number of periods along an imaginary zero line NU). In the periodic case (zero crossings through NU at a constant distance), for example, P1=P2=P.

The amplitude A of the oscillations 750 can be constant along the path of the line or can vary along the path of the line, see e.g. FIG. 8B.

FIG. 7 shows a multi-curved (e.g. serpentine or wavy) line path.

Other possible oscillating lines having a plurality of oscillations 750 are shown as examples in FIGS. 8A to 8D. Oscillations 750 can be realized at least in one or more portions of the line path. The oscillating line may be realized in the form of serpentine lines, wavy lines, meanders or polygonal lines (see FIG. 8C-triangular or zig-zag shape, and FIG. 8D-trapezoidal or rectangular or crenellated shape), whereby the polygonal lines can be designed in particular with rounded corners.

An amplitude A of the oscillating line path can be equal to or greater than 1 mm, 3 mm, 5 mm, 8 mm, 10 mm, 15 mm or 20 mm, for example. By selecting the amplitude A, a suitable width BU of the band vacuum can be set.

An average period of the oscillating line path can, for example, be equal to or less than 20 mm, 10 mm, 8 mm, 5 mm, 3 mm, 2 mm, 1 mm or 0.5 mm. The holding force can be adjusted by selecting the average period (the smaller the average period, the greater the holding force of the band vacuum can be dimensioned).

For example, a slot width of the linear vacuum slot 250 may be equal to or less than 0.1 mm, 0.08 mm, 0.06 mm, 0.05 mm, or 0.04 mm.

In a particularly advantageous example, the oscillating line path of the vacuum slot 250 is designed without kinks and/or without transverse slots, so that there are no “dead” corners or crossing points on the vacuum slot 250 at which the insert ET and, e.g., the print thereon is increasingly pressed in.

The second aspect of the disclosure further relates to an injection mold for producing a plastic molded part with an insert. The injection mold comprises a first mold half and a second mold half. The two mold halves are configured to form an injection molding cavity when closed. The first mold half has a contour surface in which a linear vacuum slot extends. The linear vacuum slot comprises an oscillating line path in order to form a band-shaped vacuum region on the contour surface, via which the insert is fixable to the contour surface by applying a vacuum.

The disclosure further includes a plastic molded part comprising a plastic component and an insert ET as described with reference to FIG. 6, wherein, however, an outer surface of the insert ET has a linear impression with an oscillating line pattern (i.e. with a plurality of oscillations 750) as described above, rather than the transverse slots shown in FIG. 6.

All features and examples relating to the first aspect of the disclosure, in particular the features relating to the linear vacuum, also apply to the second aspect of the disclosure. In particular, this relates to the structural features relating to the mold insert 260 and the receptacle 270, wherein, from a functional point of view, the distance between transverse slots 350 corresponds to the period and the length of the transverse slots 350 corresponds to the amplitude of the linear vacuum with oscillating line path. Furthermore, this relates in particular to design and procedural features for the application of vacuum. To avoid repetition, reference is therefore made to the above description of the first aspect of the invention.

Furthermore, according to a third aspect of the disclosure, it has been found that it can be advantageous to switch from vacuum to overpressure even before the (cooled) plastic molded part is removed from the injection molding cavity. For example, the overpressure (higher than the ambient air pressure, e.g. higher than 1 or 2 or 5 or 8 or 10 bar) can already be applied before the injection molding cavity is completely filled, e.g. as soon as the liquid plastic compound covers the insert ET above the band-shaped vacuum region BU. The overpressure protects the insert ET and any paint on it by causing the insert ET to be pressed less deeply into the vacuum slot, thereby reducing the undesirable embossing impression on the plastic molded part.

It is also possible to switch from vacuum to overpressure at a later point in time. As known in the art, an injection molding process may include an injection phase (also referred to as a filling phase), followed by a holding pressure phase and a subsequent cooling phase. It is also possible to switch from vacuum to overpressure during the cooling phase of the not-yet solidified plastic compound in the injection molding cavity or before the cooling phase during the holding pressure phase, which occurs between the injection phase and the cooling phase in an injection molding process. In these cases, the duration of the injection pressure acting on the insert ET is also reduced and the process reliability of production is increased.

The overpressure may continue during demolding in order to release the (solidified) molded plastic part from the contour surface 210 of the first mold half 110.

The above-described “early” switchover from vacuum to overpressure prior to the removal process (demolding) can be realized for any desired design of a vacuum slot in a contour surface of a first mold half of an injection mold. In other words, the concept of “early” switchover from vacuum to overpressure can be applied but is not limited to vacuum slots forming band-shaped vacuum regions BU as described above. It can also be applied to prior art vacuum slot.

The disclosure according to the third aspect further pertains to an injection mold for producing a plastic molded part with an insert, the injection mold comprising: a first mold half and a second mold half, which are configured to form an injection molding cavity when closed. The first mold half comprises a contour surface in which one or more vacuum slots extend, via which the insert is fixable to the contour surface by applying a vacuum. The injection mold is configured to switch the vacuum to overpressure during or before the cooling phase of the not-yet solidified plastic compound, in particular during a holding pressure phase or before the injection molding cavity is completely filled when the plastic compound is injected.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

1. A method of producing a plastic molded part with an insert by injection molding, the method comprising:
inserting the insert into a first mold half of an injection mold;
forming an injection molding cavity by closing the first mold half with a second mold half;
fixing the insert to a contour surface of the first mold half by applying a vacuum by means of a band-shaped vacuum region on the contour surface, wherein the band-shaped vacuum region is formed by a linear vacuum slot extending in the contour surface and provided with transverse slots present in the contour surface;
injecting a plastic compound into the injection molding cavity; and
demolding the plastic molded part with the insert.

2. The method of claim 1, wherein the transverse slots extend away only from one side of the linear vacuum slot.

3. The method of claim 1, wherein the transverse slots extend away from both sides of the linear vacuum slot.

4. The method of claim 1, wherein the first mold half comprises a receptacle and a mold insert arranged in the receptacle, the linear vacuum slot is delimited by a side wall of the mold insert and the transverse slots running in the mold insert open into the linear vacuum slot.

5. The method of claim 4, wherein the first mold half comprises a further mold insert arranged in the receptacle, the linear vacuum slot is delimited by the side wall of the mold insert and a side wall of the further mold insert, and the transverse slots running in the further mold insert open into the linear vacuum slot.

6. The method of claim 1, wherein a length of the transverse slots is equal to or less than 10 mm.

7. The method of claim 1, wherein a distance between adjacent transverse slots of the transverse slots is equal to or less than 20 mm.

8. The method of claim 1, wherein a slot width of at least one of the linear vacuum slot or the transverse slots is equal to or less than 0.1 mm.

9. The method of claim 1, wherein the transverse slots communicate with a vacuum channel extending below the transverse slots.

10. The method of claim 1, wherein during or before a cooling phase of the plastic compound prior to the plastic compound being solidified, the vacuum is switched to an overpressure.

11. A method of manufacturing a plastic molded part with an insert by injection molding, the method comprising:
inserting the insert into a first mold half of an injection mold;
forming an injection molding cavity by closing the first mold half with a second mold half;
fixing the insert to a contour surface of the first mold half by applying a vacuum by means of a band-shaped vacuum region on the contour surface, wherein the band-shaped vacuum region is formed by a vacuum slot with an oscillating line path provided in the contour surface;
injecting a plastic compound into the injection molding cavity; and
demolding the plastic molded part with the insert.

12. The method of claim 11, wherein the oscillating line path is realized without kinks or transverse slots at least in some areas.

13. The method of claim 11, wherein the oscillating line path is realized at least in some areas as a multi-curved, serpentine, wavy, meandering or polygonal line with rounded corners.

14. The method of claim 11, wherein an amplitude of the oscillating line path is equal to or greater than 1 mm.

15. The method of claim 11, wherein an average period of the oscillating line path is equal to or less than 20 mm.

16. The method of claim 11, wherein a slot width of the vacuum slot is equal to or less than 0.1 mm.

17. The method of claim 11, wherein the first mold half comprises a receptacle and a mold insert arranged in the receptacle and the vacuum slot is delimited by a side wall of the mold insert and a side wall of the receptacle.

18. A method of producing a plastic molded part with an insert by injection molding, the method comprising:
inserting the insert into a first mold half of an injection mold;
forming an injection molding cavity by closing the first mold half with a second mold half;
fixing the insert to a contour surface of the first mold half by applying a vacuum by means of one or more vacuum slots in the contour surface;
injecting a plastic compound into the injection molding cavity; and
demolding the plastic molded part with the insert, wherein during or before a cooling phase of the plastic compound prior to the plastic compound being solidified, the vacuum is switched to an overpressure.

19. The method of claim 18, wherein the vacuum is switched to the overpressure during or before a holding pressure phase of the injection molding.

20. The method of claim 18, wherein the vacuum is switched to the overpressure before the injection molding cavity is completely filled when the plastic compound is injected.
